(19) United States
(12) Patent Application Publication
(10) Pub. No.: US 2026/0193911 A1
(43) Pub. Date: Jul. 9, 2026

(54) SIDE DOOR RELEASE SWITCH INTEGRATED INTO EXTERIOR MOLDING

(71) Applicant: GM GLOBAL TECHNOLOGY OPERATIONS LLC, DETROIT, MI (US)

(72) Inventors: Darren M. Van Houzen, Shelby Twp, MI (US); James C. O’Kane, Shelby Twp, MI (US)

(21) Appl. No.: 19/014,760

(22) Filed: Jan. 9, 2025

(51) Int. Cl. E05B 85/00; B60Q 1/26

(52) U.S. Cl. CPC E05B 85/00; B60Q 1/2669

(57) ABSTRACT

A door opening switch system of a vehicle includes a switch located in a body of a vehicle configured to operate a door latch of a side door of the vehicle, and a button operably connected to the switch and located at an exterior surface of the body. The button is operable to activate the switch when the button is depressed by a user. The switch is located remotely from the button and the button is operably connected to the switch by a push member connecting the button to the switch.

### BACKGROUND

The subject disclosure relates to vehicles, and in particular to door opening systems for vehicles.

Vehicles include door opening systems that, when activated, open a door of the vehicle to allow access for a user of the vehicle. The systems, in some configurations, utilize an electrical switch that unlatches or opens the door when the user activates the switch by, for example, pushing a button or using another activation device to operate the switch. For vehicle styling and user appeal, it is often desired to embed the switch and button as much as possible into the vehicle body or one of its trim components. This embedding of the switch and button into the trim component typically results in enlarging of the trim component to accommodate these elements, which can be unappealing from a vehicle styling and user appeal perspective.

### SUMMARY

In one exemplary embodiment, a door opening switch system of a vehicle includes a switch located in a body of a vehicle configured to operate a door latch of a side door of the vehicle, and a button operably connected to the switch and located at an exterior surface of the body. The button is operable to activate the switch when the button is depressed by a user. The switch is located remotely from the button and the button is operably connected to the switch by a push member connecting the button to the switch.

In addition to one or more of the features described herein, the system includes a housing in which the switch is positioned, and the push member extends through a housing end of the housing toward the button.

In addition to one or more of the features described herein, a seal is positioned at the housing end, and the push member extends through the seal.

In addition to one or more of the features described herein, the push member is formed from one of a translucent or transparent material.

In addition to one or more of the features described herein, a light element is configured to project light onto or along the push member.

In addition to one or more of the features described herein, the button is depressed in a direction toward the switch.

In another exemplary embodiment, a door opening system of a vehicle includes a door latch positioned and configured to open a side door of a vehicle when the door latch is operated, and a switch located inside of a body of the vehicle. The switch is configured to operate the door latch when the switch is activated. A button is operably connected to the switch and is located at an exterior surface of the body. The button is operable to activate the switch when the button is depressed by a user. The switch is located remotely from the button, and the button is operably connected to the switch by a push member connecting the button to the switch.

In addition to one or more of the features described herein, the button is positioned at a belt line molding of the vehicle.

In addition to one or more of the features described herein, the button is positioned flush with an exterior surface of the belt line molding.

In addition to one or more of the features described herein, the switch is positioned vertically below the belt line molding.

In addition to one or more of the features described herein, the system includes a housing in which the switch is positioned and the push member extends through a housing end of the housing toward the button.

In addition to one or more of the features described herein, a seal is positioned at the housing end, and the push member extends through the seal.

In addition to one or more of the features described herein, the push member is formed from one of a translucent or transparent material.

In addition to one or more of the features described herein, a light element is configured to project light onto or along the push member.

In yet another exemplary embodiment, a vehicle includes a vehicle body, with the vehicle body including a side door. The vehicle further includes a door opening system including a door latch positioned and configured to open the side door when the door latch is operated and a switch located inside of the vehicle body. The switch is configured to operate the door latch when the switch is activated. A button is operably connected to the switch and is located at an exterior surface of the body. The button is operable to activate the switch when the button is depressed by a user. The switch is located remotely from the button, and the button is operably connected to the switch by a push member connecting the button to the switch.

In addition to one or more of the features described herein, the button is positioned at a belt line molding of the vehicle.

In addition to one or more of the features described herein, the belt line molding is installed to a rear quarter panel of the vehicle.

In addition to one or more of the features described herein, the switch is positioned vertically below the belt line molding.

In addition to one or more of the features described herein, the door opening system includes a housing in which the switch is positioned, and the push member extends through a housing end of the housing toward the button.

In addition to one or more of the features described herein, a seal is positioned at the housing end, and the push member extends through the seal.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of an embodiment of a vehicle;

FIG. 2 is a schematic illustration of an embodiment of a belt molding of a vehicle;

FIG. 3 is a cross-sectional view of an embodiment of a door opening system of a vehicle;

FIG. 4. is a schematic illustration of an inside view of a quarter panel assembly with a switch installed thereto;

FIG. 5 is a cross-sectional illustration of an embodiment of a door opening switch system; and

FIG. 6 is a perspective illustration of an embodiment of a door switch and button installed to a belt molding.

### DETAILED DESCRIPTION

The following description is merely exemplary in nature and is not intended to limit the present disclosure, its application or uses. It should be understood that throughout the drawings, corresponding reference numerals indicate like or corresponding parts and features.

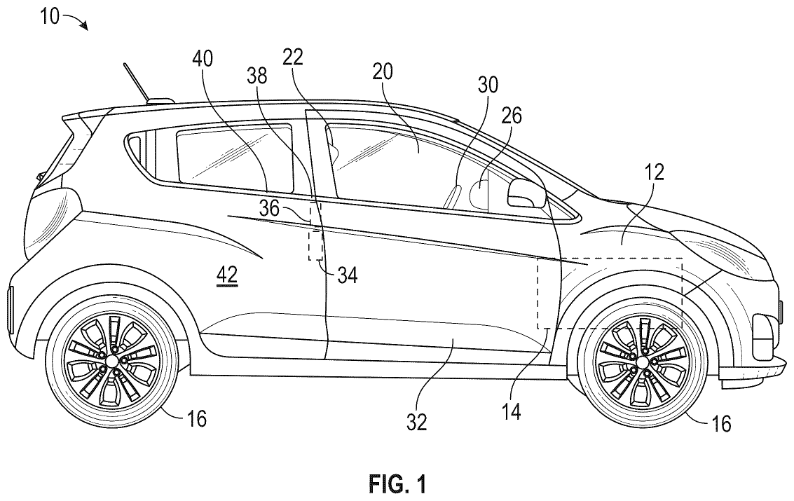

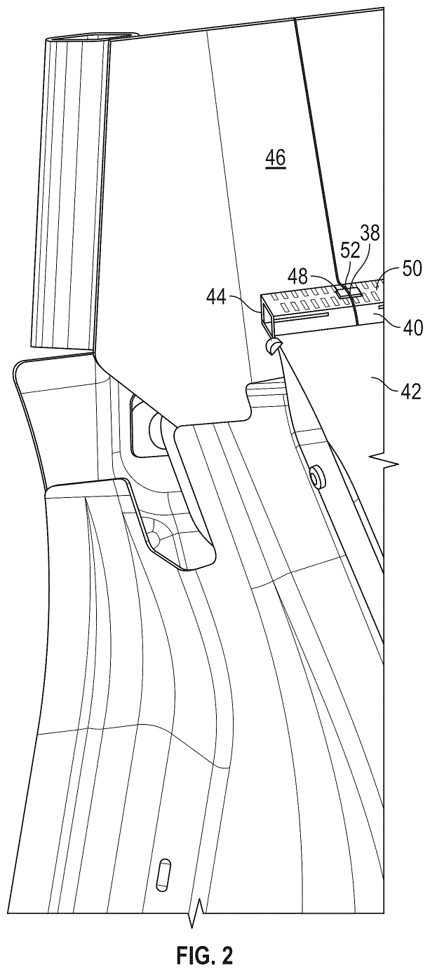

In accordance with an exemplary embodiment a vehicle is indicated generally at 10 in FIG. 1. Vehicle 10 includes a body 12 supported on a plurality of wheels 16 connected to a propulsion system 14, such as an engine. In a non-limiting example, two of the plurality of wheels 16 are steerable. Body 12 defines, in part, an occupant compartment 20 having seats 22 positioned behind a dashboard 26. A steering control 30 is arranged between seats 22 and dashboard 26. Steering control 30 is operated to control orientation of the steerable wheel(s) 16. The body 12 includes one or more side doors 32, that are openable and closable via a door latch 34. The door latch 34 is operated by a switch 36 operated by a user. In the embodiment illustrated, the switch 36 is operated by the user via a button 38 located at the exterior of the body 12, for example, in a belt molding 40 located at rear quarter panel 42 of the body 12, as also shown in FIG. 2.

Referring to FIG. 2, the belt molding 40 is fixed to the rear quarter panel 42 and includes a molding lip 44 formed from a relatively soft material, such as an elastomer material. The molding lip 44 abuts a side window 46 of the vehicle 10 to seal between the rear quarter panel 42 and the side window 46. The belt molding 40 includes a molding opening 48 in a molding outer surface 50 in which the button 38 is positioned. In some embodiments a button top surface 52 is positioned flush with the molding outer surface 50.

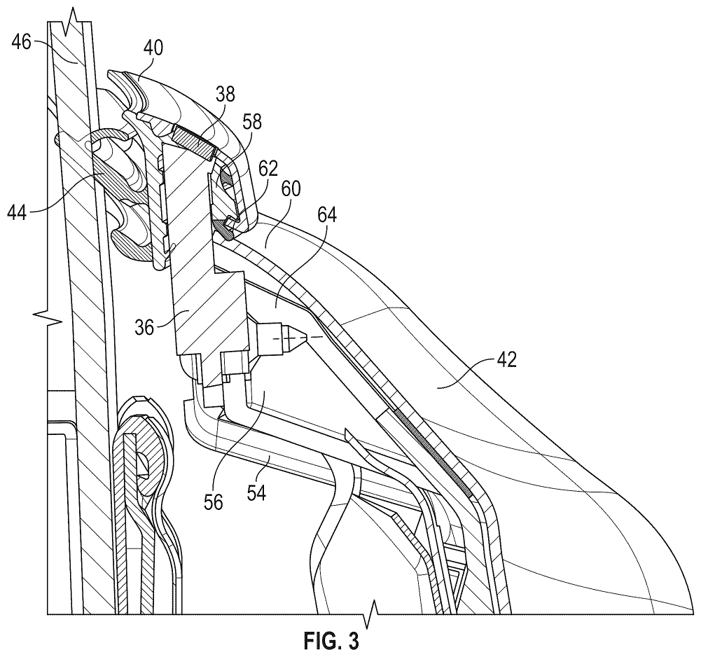

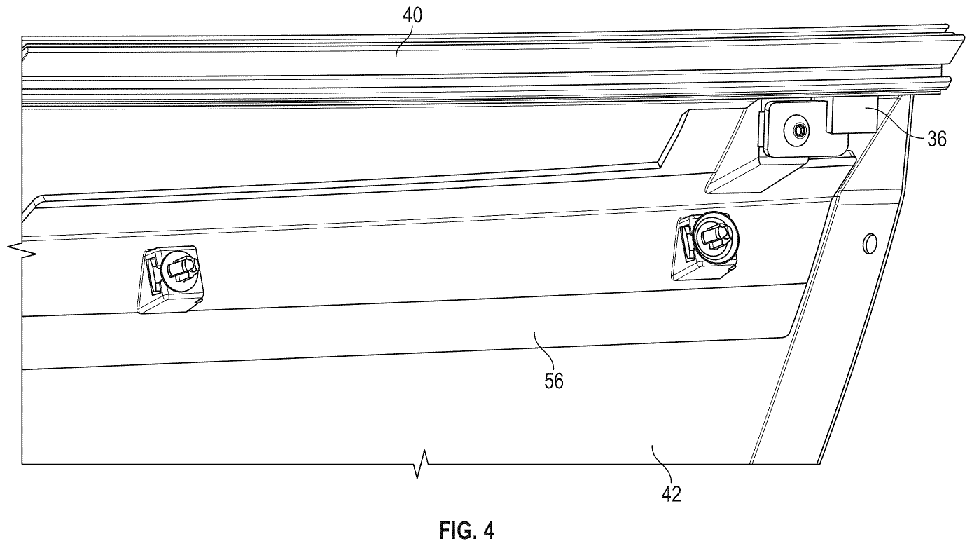

As shown in the cross-sectional view of FIG. 3, the switch 36 is located remotely from the button 38, and is not positioned inside the belt molding 40. The rear quarter panel 42 is installed over a quarter panel inner 54 with a spacer 56 disposed between the rear quarter panel 42 and the quarter panel inner 54. The belt molding 40 is installed to an upper flange 58 of the rear quarter panel 42, which also defines a belt molding shelf 60 at which a lower molding portion 62 of the belt molding 40 is positioned. Vertically below the belt molding shelf 60, the rear quarter panel 42 and the quarter panel inner 54 are spaced apart and define a panel cavity 64 therebetween. The switch 36 is positioned in the panel cavity 64, and in some embodiments is secured to the spacer 56. This is illustrated in FIG. 4, which depicts the inside rear quarter panel 42 with the belt molding 40, the spacer 56 and the switch 36 as a unitary subassembly.

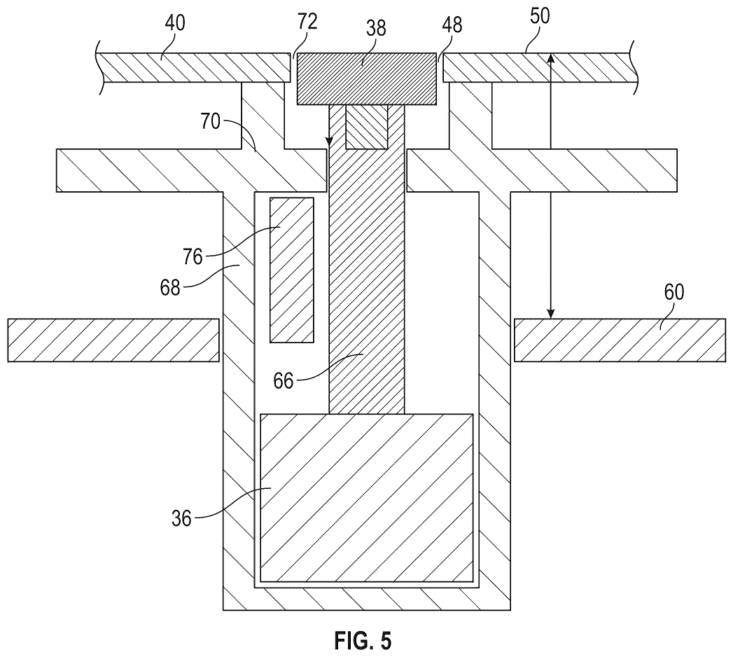

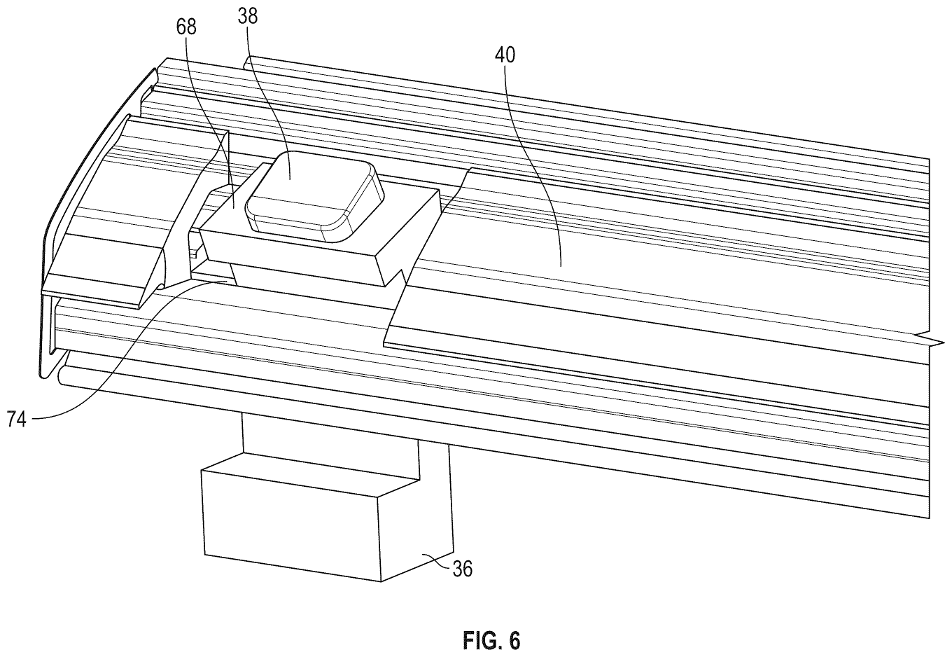

Referring now to FIG. 5, the switch 36 is connected to the button 38 by a push member 66 extending from the button 38 to the switch 36, such that when the button 38 is depressed by a user the switch 36 is activated. The switch 36 is positioned vertically below the belt molding shelf 60, and in some embodiments is disposed in a housing 68, which may also include at least a portion of the push member 66 therein. As shown in FIG. 6, the belt molding 40 has a molding notch 74 formed therein and extending downwardly from the molding outer surface 50 to accommodate the housing 68, the switch 36 and push member 66 disposed therein.

Referring again to FIG. 5, a seal 70, such as a flexible elastomeric seal, may enclose the housing 68 at a vertically upper end of the housing 68, while allowing the push member 66 to protrude therethrough for connection to the button 38. The seal 70 is configured to prevent intrusion of contaminants such as water, dirt or other debris into the door cavity in which the switch 36 is located, thereby improving a usable service life of the switch 36. While a flexible elastomeric seal 70 is utilized in some embodiments, in other embodiments the seal 70 may have other configurations, such as a rigid seal, a brush seal or the like.

The push member 66 is a rigid member, and in some embodiments may be formed integral to the button 38. Alternatively, the push member 66 may be secured to the button 38 by one or more of bonding, an adhesive, or with one or more mechanical fasteners. In some embodiments, the push member 66 is formed from a transparent or translucent material, such as a clear or semi-clear plastic. Additionally, a light element 76 may be positioned in the housing 68 to direct illumination toward or along the push member 66. In some embodiments, the light element 76 is a light-emitting diode (LED), emitting a preselected light color. In some embodiments, the light color may be varied by the user, or may vary depend on operating state of the switch 36, such as a locked or unlocked state. Illumination of the push member 66 utilizing the light element 76 also at least partially illuminates the button 38 with light appearing in a button gap 72 between a perimeter of the button 38 and the molding outer surface 50. In other embodiments, the button 38 may have a transparent or translucent portion, so that the illumination of the push member 66 by the light element 76 also illuminates the transparent or translucent portion of the button 38.

In some embodiments, the switch 36 has a pre-determined stroke, for example, 3 millimeters. required to activate the switch 36. Thus the button 38 and the seal 70 are positioned such that the required stroke may be attained to activate the switch 36 prior to the button 38 contacting the seal 70 when the button 38 is depressed. Therefore, in some embodiments the seal 70 is positioned at at least the pre-determined stroke distance vertically below the molding outer surface 50 to allow the button 38 to travel the required stroke distance before contacting the seal 70.

Locating the switch 36 remotely from the button 38 through the use of the push member 66 allows for the switch 36 to be positioned in an existing panel cavity 64, vertically below the belt molding shelf 60. Thus the belt molding 40 does not need to be enlarged to accommodate the switch 36. While in the embodiments herein the switch 36 is disposed at the rear quarter panel 42 of the vehicle body 12, and is utilized to operate a side door 32, one skilled in the art will readily appreciate that the switch 36 may similarly be installed in the side door 32, with the button being located in a belt molding of the side door 32.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A door opening switch system of a vehicle, comprising:
a switch located in a body of a vehicle configured to operate a door latch of a side door of the vehicle; and
a button operably connected to the switch and located at an exterior surface of the body, the button operable to activate the switch when the button is depressed by a user;
wherein the switch is located remotely from the button, the button operably connected to the switch by a push member connecting the button to the switch.

2. The door opening switch system of claim 1, further comprising a housing in which the switch is disposed and wherein the push member extends through a housing end of the housing toward the button.

3. The door opening switch system of claim 2, further comprising a seal disposed at the housing end, the push member extending through the seal.

4. The door opening switch system of claim 1, wherein the push member is formed from one of a translucent or transparent material.

5. The door opening switch system of claim 1, further comprising a light element configured to project light onto or along the push member.

6. The door opening switch system of claim 1, wherein the button is depressed in a direction toward the switch.

7. A door opening system of a vehicle comprising:
a door latch disposed and configured to open a side door of a vehicle when the door latch is operated;
a switch located inside of a body of the vehicle, the switch configured to operate the door latch when the switch is activated; and
a button operably connected to the switch and located at an exterior surface of the body, the button operable to activate the switch when the button is depressed by a user;
wherein the switch is located remotely from the button, the button operably connected to the switch by a push member connecting the button to the switch.

8. The door opening system of claim 7, wherein the button is disposed at a belt line molding of the vehicle.

9. The door opening system of claim 8, wherein the button is disposed flush with an exterior surface of the belt line molding.

10. The door opening system of claim 8, wherein the switch is disposed vertically below the belt line molding.

11. The door opening system of claim 7, further comprising a housing in which the switch is disposed and wherein the push member extends through a housing end of the housing toward the button.

12. The door opening system of claim 11, further comprising a seal disposed at the housing end, the push member extending through the seal.

13. The door opening system of claim 7, wherein the push member is formed from one of a translucent or transparent material.

14. The door opening system of claim 7, further comprising a light element configured to project light onto or along the push member.

15. A vehicle, comprising:
a vehicle body, the vehicle body including a side door; and
a door opening system including:
a door latch disposed and configured to open the side door when the door latch is operated;
a switch located inside of the vehicle body, the switch configured to operate the door latch when the switch is activated; and
a button operably connected to the switch and located at an exterior surface of the vehicle body, the button operable to activate the switch when the button is depressed by a user;
wherein the switch is located remotely from the button, the button operably connected to the switch by a push member connecting the button to the switch;
wherein the switch is located vertically below the button.

16. The vehicle of claim 15, wherein the button is disposed at a belt line molding of the vehicle.

17. The vehicle of claim 16, wherein the belt line molding is installed to a rear quarter panel of the vehicle.

18. The vehicle of claim 16, wherein the switch is disposed vertically below the belt line molding.

19. The vehicle of claim 15, further comprising a housing in which the switch is disposed and wherein the push member extends through a housing end of the housing toward the button.

20. The vehicle of claim 19, further comprising a seal disposed at the housing end, the push member extending through the seal.
